(19) United States
(12) Patent Application Publication
(10) Pub. No.: US 2010/0035121 A1
(43) Pub. Date: Feb. 11, 2010

(54) FUEL CELL SEPARATOR AND FUEL CELL

(76) Inventors: Kazunori Shibata, Shizuoka-ken (JP); Masaaki Kondo, Aichi-ken (JP); Syo Usami, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/531,086

(22) PCT Filed: Mar. 14, 2008
(86) PCT No.: PCT/JP2008/055191

§ 371 Date: Sep. 14, 2009

(30) Foreign Application Priority Data
Apr. 20, 2007 (JP) 2007-111086

(51) Int. Cl. H01M 2/02

(52) U.S. Cl. 429/34

(57) ABSTRACT

This separator is equipped with a first plate 33 and a second plate 32. The first plate 33 has a first hole 3341 through which reaction gas flows. The second plate 32 is to be stacked with the first plate 33, and has a second hole 3241 through which the reaction gas flows. The second hole 3241 overlaps with the first hole 3341 at the first part 3231, and is in fluid communication with the first hole 3341. The second plate 32 has a partition part 323 that divides the part 3247 of the second part which does not overlap the first hole 3341 among the second holes 3241 into a plurality of flow path parts 56. The separator 30 is further equipped with an oscillating portion 325. The oscillating portion 325 is connected to the partition part 323. The oscillating portion 325 is arranged at a position such that part of the oscillating portion 325 overlaps with the first hole 3341 of the first plate 33. The oscillating portion 325 is provided so as to be shaken by the reaction gas that flows inside the first hole 3341.

### TECHNICAL FIELD

The present invention relates to a fuel cell separator and a fuel cell.

### BACKGROUND ART

Conventionally, in fuel cells, a three layer structure separator was used in which a reaction gas flow path was formed with three plates stacked. For example, with certain of the prior art, a separator 1 is equipped with a fuel gas plate 3, an oxidant gas plate 4, and an intermediate plate 5. A gas transfer flow path 30 provided on the intermediate plate 5 consists of a plurality of slits. The transfer flow path 30 receives oxidant gas 23 used for reactions via a through-hole 22 provided on the oxidant gas plate 4. Then, the transfer flow path 30 exhausts the oxidant gas 23 to the gas communication hole 19 provided on the oxidant gas plate 4 and the fuel gas plate 3. By having the gas transfer flow path 30 formed from a plurality of slits, it is possible to increase the rigidity of the intermediate plate 5.

However, with the embodiment noted above, the water generated by the cathode electrode (oxygen electrode) is contained in the oxidant gas 23 after flowing through the cathode electrode, this becomes liquid inside the slit of the gas transfer flow path 30 and is accumulated. The slit may be blocked by the accumulated water. This kind of problem is not limited to the gas flow path for exhausting used oxidation gas, but can occur in a wide range of cases for a gas flow path for flowing reaction gas (including oxidation gas and fuel gas) within the fuel cell, which is a gas flow path for flowing gas that can contain moisture constituted from a plurality of flow path parts.

The present invention deals with at least part of the problems of the prior art described above. The purpose of the present invention is to make it difficult for water to accumulate in the gas flow path constituted from a plurality of flow path parts within the fuel cell that flows gas that can contain moisture.

The contents disclosed in Japanese Patent Application No. 2007-111086 are incorporated in this specification for reference.

### DISCLOSURE OF THE INVENTION

To handle at least part of the problems noted above, for a fuel cell separator as one mode of the present invention, the following aspect may be applied. This separator comprises: a first plate having a first hole through which reaction gas flows; and a second plate that is to be stacked with the first plate. The second plate has a second hole through which the reaction gas flows. The second hole is in fluid communication with the first hole.

The second hole has: a first part that overlaps with the first hole; and a second part that does not overlap with the first hole. The second plate has a partition part that divides the second part into a plurality of flow path parts through which the reaction gas flows respectively. The separator further comprises an oscillating portion that is connected to the partition part or other inner wall that constitutes the flow path part. The oscillating portion is arranged at a position in which at least part of the oscillating portion overlaps with the first hole of the first plate. The oscillating portion is configured to be shaken by the reaction gas that flows in the first hole during operation of the fuel cell.

With this aspect, when operating the fuel cell, the oscillating portion is shaken by the reaction gas flowing within the first hole. By this oscillation, the water in the flow path part is efficiently exhausted to outside the flow path part. Thus, it is difficult for water to accumulate inside the plurality of flow path parts. Note that the oscillating portion is preferably provided with, at least in part, having a level of rigidity that bends with the flow of the reaction gas. Also, of the second hole, at least part of the portion which not overlapped with the first hole may be divided into a plurality of flow path parts.

In one aspect, the oscillating portion, at the second part side from among the first part side and the second part side of the second hole, may be connected to the partition part or other inner wall part that constitutes the flow path part. At the first part side, the oscillating portion may not be connected to a part that constitutes the first or second plate.

In such an aspect, the oscillating portion is supported at one side (the second part side). As a result, when the fuel cell operates, the oscillating portion can be shaken by the reaction gas that flows in the first hole and in the first part of the second hole.

In an aspect in which the second plate has a plurality of partition parts, the plurality of partition parts may be connected to one oscillating portion.

With such an aspect, when the fuel cell is operated, even in cases when there is local variation in the flow volume per unit of time of gas flowing within the first hole, it is possible to exhaust water equally for each flow path part.

In another aspect, the second plate may have a plurality of partition parts, and the plurality of partition parts may be connected to respectively different oscillating portions.

With this aspect, when the gas flow is strong at part within the first hole, the oscillating portion positioned at that part oscillates strongly. As a result, it is possible to efficiently exhaust the water of the flow path part near that oscillating portion.

Note that when producing the second plate, the oscillating portion can be generated as part of the second plate. With this aspect, it is possible to use a simple constitution for the separator.

Also, as one aspect of the present invention, a fuel cell comprising: a plurality of separators; and a membrane electrode assembly arranged between the plurality of separators may be preferable.

In above aspect, it is preferable that the plurality of separators are stacked so that at least part of the first holes mutually overlap. In some aspect having those features, during operation of the fuel cell, the reaction gas exhausted from the membrane electrode assembly via the second holes of the separators flows in a specified direction along the stacking direction in the first holes of the plurality of stacked separators. A first separator from among the plurality of separators may preferably comprise the oscillating portion of which surface area is smaller, when projected in the stacking direction, than that of a second separator from among the plurality of separators, which is positioned upstream of the first separator in the direction of the flow of the reaction gas.

With this aspect, at the downstream side at which the reaction gas flow volume per unit of time is large, an oscillating portion with a small projection surface area is equipped, and at the upstream side at which the reaction gas flow volume per unit of time is small, an oscillating portion with a large projection surface area is equipped. Accordingly, at the upstream, it is possible to catch gentle gas flow with the large oscillating portion, and at the downstream, it is possible to catch strong gas flow with the small oscillating portion. As a result, it is possible to reduce the difference in oscillation volume of the oscillating portions at upstream and downstream, and consequently to reduce the variation of the ease of exhausting water of the plurality of flow path parts.

In another aspect, during operation of the fuel cell, the reaction gas supplied to the membrane electrode assembly via the second holes of the separators flows in a specified direction along the stacking direction in the first holes of the plurality of stacked separators. In such an aspect, it is preferable that a first separator from among the plurality of separators comprises the oscillating portion of which surface area is larger, when projected in the stacking direction, than that of a second separator from among the plurality of separators, which is positioned at upstream of the first separator in the direction of the flow of the reaction gas.

In this aspect, at the upstream side at which the reaction gas flow volume per unit of time is large, an oscillating portion with a small projection surface area is equipped, and at the downstream side at which the reaction gas flow volume per unit of time is small, an oscillating portion with a large projection surface area is equipped. Accordingly, at the upstream, it is possible to catch strong gas flow with the small oscillating portion, and at the downstream, it is possible to catch gentle gas flow with the large oscillating portion. As a result, it is possible to reduce the difference in oscillation volume of the oscillating portions at upstream and downstream, and consequently to reduce the variation of the ease of exhausting water of the plurality of flow path parts.

Furthermore, as one mode of the present invention, it is also possible to use the kind of separator noted below. The fuel cell separator comprises: a first plate having a first and second holes through which reaction gas flows; and a second plate that is to be stacked with the first plate. The second plate has a third hole through which the reaction gas flows.

The third hole has: a first part that overlaps with the first hole; and a second part that does not overlap with the first hole but partly overlaps with the second hole. At least one of the first plate and the second plate has a partition part which divides, in a state that the first plate and the second plate being stacked, at least part of the second part into a plurality of flow path parts through which the reaction gas flows respectively. A tip of the partition part is positioned overlapping with the first hole.

With this aspect, when operating the fuel cell, the water inside the second part of the third hole adheres to the partition part. Then, the water adhered to the tip of the partition part is carried away by the reaction gas that flows through the first hole and the first part of the third hole. As a result, the water within the flow path part is efficiently exhausted to outside the flow path part. Thus, with the aspect noted above, it is difficult for water to accumulate inside the plurality of flow path parts.

Note that as one aspect of the present invention, a fuel cell is preferable which is equipped with a plurality of the aforementioned separators having a first plate which has first and second holes and a second plate which has a third hole, and membrane electrode assemblies placed between these plurality of separators.

The present invention can be realized in various aspects other than those noted above, and for example can be realized with modes such as a fuel cell equipped with fuel cell separators, a fuel cell system, and the manufacturing method of these, or the like.

Following, preferred embodiments of the invention of this application is described in detail while referring to the drawings, and the purpose described above will be clear as well as other purposes of the invention of this application, its constitution, and effect.

### BRIEF DESCRIPTION OF THE DRAWINGS

FIG. 1 is a cross section view of the fuel cell 1 as an embodiment of the present invention.

FIG. 2 is a plan view of the MEA integrated seal unit 20.

FIG. 3 is a plan view showing the cathode side plate 31.

FIG. 4 is a plan view showing the intermediate plate 32.

FIG. 5 is a plan view showing the anode side plate 33.

FIG. 6 is an expanded view near the hole 3241 of the intermediate plate 32.

FIG. 7 is an expanded view near the hole 3241 of the intermediate plate 32 of the second embodiment.

FIG. 8 is an expanded view near the hole 3241 of the intermediate plate 32 of the third embodiment.

FIG. 9 is an expanded view near the hole 3241 of the intermediate plate 32 of the fourth embodiment.

FIG. 10 is an expanded view near the hole 3241 of the intermediate plate 32 of the fifth embodiment.

FIG. 11 is an expanded view near the hole 3241 of the intermediate plate 32 of a variation example.

### BEST MODE FOR CARRYING OUT THE INVENTION

### A. First Embodiment:

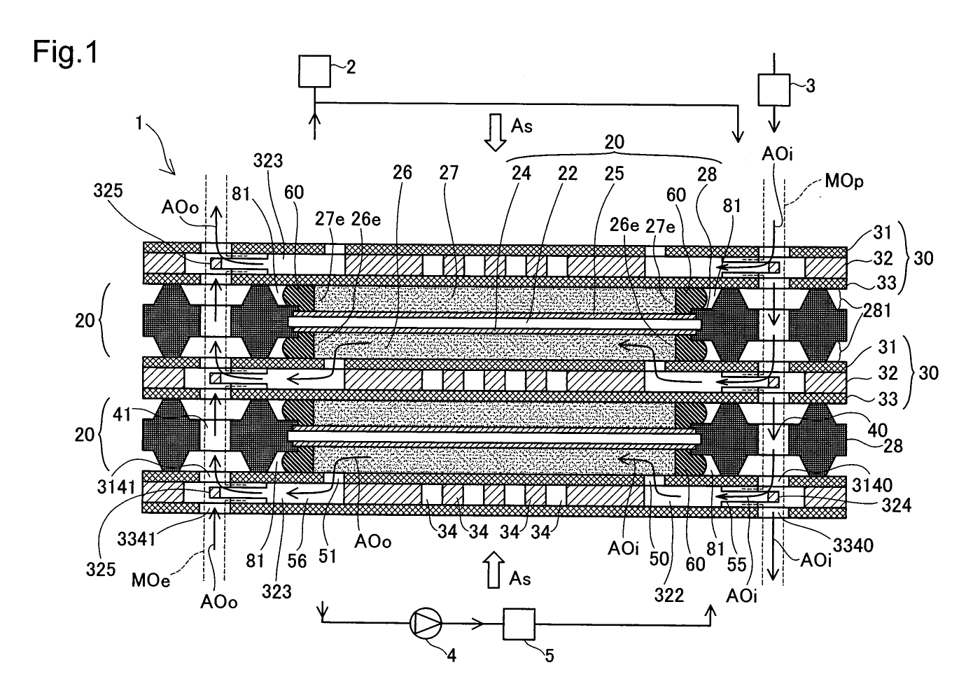

FIG. 1 is a cross section view of the fuel cell 1 as an embodiment of the present invention. This fuel cell 1 is constituted with alternate lamination of membrane electrode assembly integrated seal units 20 and separators 30. Gas flow path units 26 and 27 are arranged between the membrane electrode assembly integrated seal units 20 and the separators 30. Note that hereafter, the membrane electrode assembly integrated seal unit 20 will be noted as the “MEA (Membrane Electrode Assembly) integrated seal unit 20.”

End plates (not illustrated) are arranged at both ends of the lamination direction of the laminated body containing these MEA integrated seal units 20, gas flow path units 26 and 27, and separators 30. By having the end plates of both ends fastened to each other, with the MEA integrated seal units 20, the gas flow path units 26 and 27, and the separators 30, pressure is applied in the lamination direction As, and a cell stack of fuel cells is formed.

It is possible to constitute a fuel cell system using this fuel cell 1, a fuel gas supply unit 2, such as a hydrogen tank, that supplies fuel gas to the fuel cell stack, an oxidation gas supply unit 3, such as an air pump, that supplies oxidation gas to the fuel stack, a refrigerant circulation unit 4, such as a circulation pump, that supplies refrigerant to the fuel cell stack, and a refrigerant cooling unit 5, such as a radiator, that cools the refrigerant to be supplied to the fuel cell stack.

The MEA integrated seal unit 20 is a roughly plate shaped member which is rectangular. The MEA integrated seal unit 20 has a membrane electrode assembly 22, gas diffusion layers 24 and 25 constituted at both sides of the membrane electrode assembly 22, and a seal unit 28 constituted as a single unit with the membrane electrode assembly 22 and the gas diffusion layers 24 and 25 at their outer periphery. Note that hereafter, the membrane electrode assembly 22 is noted as the “MEA (Membrane Electrode Assembly) 22.”

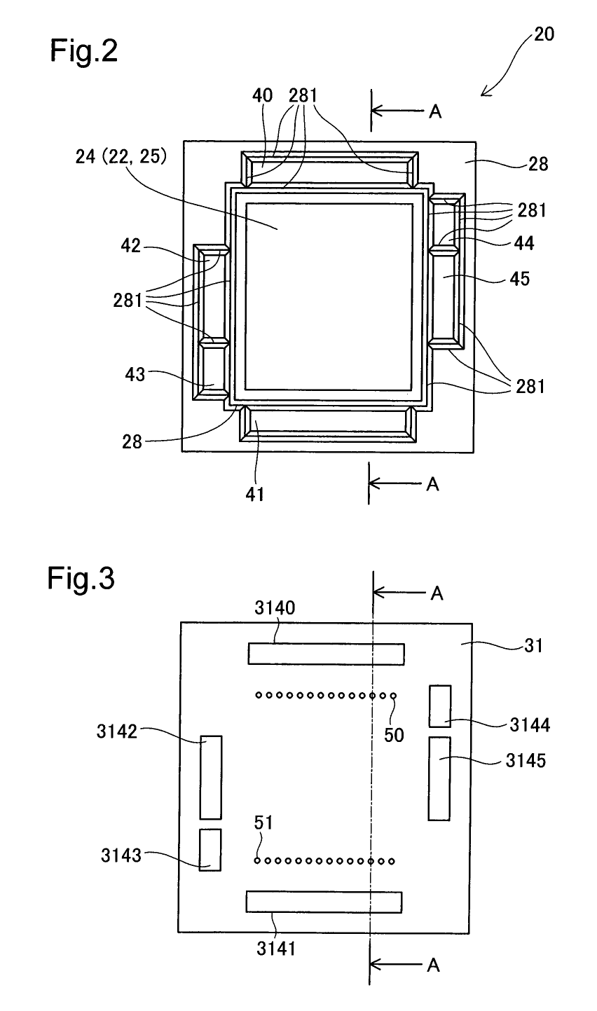

FIG. 2 is a plan view of the MEA integrated seal unit 20. The cross section diagram of the MEA integrated seal unit 20 shown in FIG. 1 correlates to the cross section view of the A-A cross section of FIG. 2. The seal unit 28 is constituted on the outer periphery of the mutually laminated MEA 22 and the gas diffusion layers 24 and 25 which are respectively constituted in rectangular form. The seal unit 28 is formed using an insulation resin material such as silicon rubber, fluorine-containing rubber, for example. The seal unit 28 is formed as a single unit with the MEA 22 by injection molding.

On the seal unit 28 are provided holes 40 through 45 that passing through the seal unit 28 in the lamination direction of the MEA 22 and the gas diffusion layers 24 and 25. The hole 40 and hole 41 sandwich the MEA 22 and are provided on opposite sides. Then, the hole 40 and hole 41 are respectively provided near two facing sides at the rectangular MEA integrated seal unit 20.

The hole 43 and hole 44 sandwich the MEA 22 and are provided on opposite sides. The hole 43 and hole 44 are respectively provided near different sides from the two sides near which the hole 40 and hole 41 are provided at the rectangular MEA integrated seal unit 20.

The hole 42 and hole 45 also sandwich the MEA 22 and are provided on opposite sides. The hole 42 and hole 45 respectively are provided near the same side as the two sides near which the hole 43 and hole 44 are provided at the rectangular MEA integrated seal unit 20.

These holes 40 through 45 respectively have the outer periphery enclosed by the ridge part 281 which is part of the seal unit 28. The ridge part 281 projects to both sides (in FIG. 2, paper surface directions to the front side and back side of the paper) of the lamination direction of the MEA integrated seal units 20 and the separators 30 with the seal unit 28. As a result, between the separator 30 and the separator 30, holes 40 through 45 are respectively sealed independently (see FIG. 1 and FIG. 2).

Similarly, of the gas diffusion layers 24 and 25, the part exposed to the outer surface at the center part of the MEA integrated seal unit 20 also has its outer periphery enclosed by the ridge part 281. As a result, the gas diffusion layers 24 and 25 are respectively sealed independently between the separator 30 and the separator 30.

The gas flow path units 26 and 27 (see FIG. 1) are porous bodies having air gaps that communicate with each other. The gas flow path units 26 and 27 can be constituted from a porous metal with high corrosion resistance, for example. The gas flow path units 26 and 27 are arranged in contact with the gas diffusion layers 24 and 25 at both sides of the MEA 22. Then, the gas flow path units 26 and 27 are sandwiched by the MEA integrated seal unit 20 and the separator 30.

These gas flow path units 26 and 27 are able to respectively transmit oxidation gas and fuel gas. The gas flow path unit 26 conveys oxidation gas to the gas diffusion layer 24. The gas flow path unit 27 conveys fuel gas to the gas diffusion layer 25 (See FIG. 1).

Between the MEA integrated seal unit 20 and the separator 30, of the gas flow path units 26 and 27, the part that does not contact the MEA integrated seal unit 20 or the separator 30 (the outer perimeter end parts 26e and 27e, for example) are sealed using a filler 60. As a result, with the fuel cell 1, the fuel gas and the oxidation gas supplied from the separator 30 do not flow through the gap between the seal unit 28 and the gas flow path units 26 and 27, but do flow inside the gas flow path units 26 and 27 (see arrow AOi of FIG. 1).

The separator 30 is a plate shaped member of which the shape and size are almost equal to those of the MEA integrated seal unit 20. The separator 30 is equipped with a cathode side plate 31, an anode side plate 33, and an intermediate plate 32 positioned between the cathode side plate 31 and the anode side plate 33 (see FIG. 1).

Each plate is constituted by a material that does not transmit oxidation gas and reaction gas, such as stainless steel. Each plate has a hole at a position overlapping with the holes 40 through 45 of the MEA integrated seal unit 20 when the separators 30 and the MEA integrated seal units 20 are laminated. The holes of the cathode side plate 31 at the positions corresponding respectively to the holes 40 to 45 of the MEA integrated seal unit 20 are called holes 3140 through 3145. The holes of the intermediate plate 32 at the positions corresponding to the respective holes 40 to 45 of the MEA integrated seal unit 20 are called holes 3240 through 3244. The holes of the anode side plate 33 at the positions corresponding respectively to the holes 40 through 45 of the MEA integrated seal unit 20 are called holes 3340 through 3345.

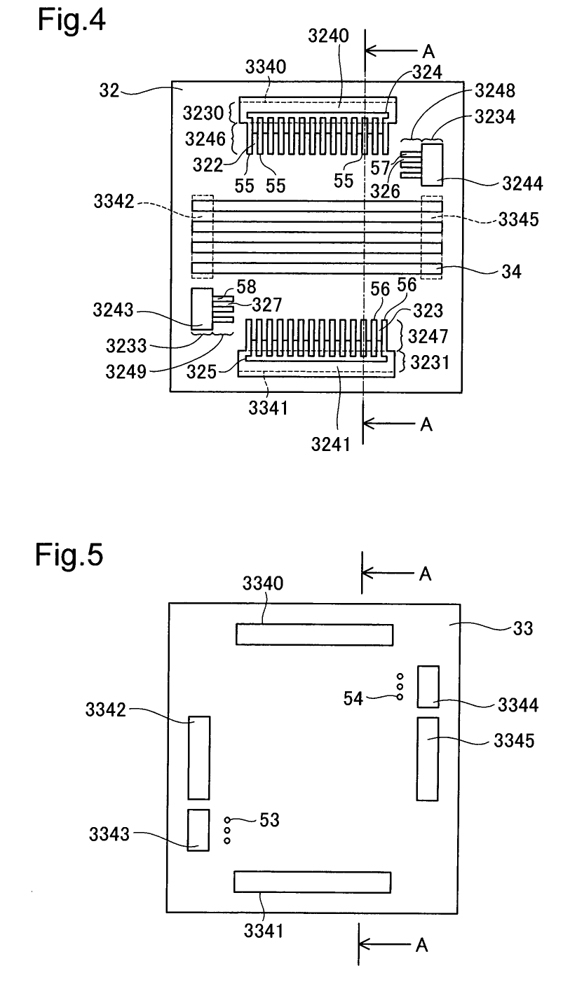

FIG. 3 is a plan view showing the cathode side plate 31. FIG. 4 is a plan view showing the intermediate plate 32. FIG. 5 is a plan view showing the anode side plate 33. The cross section views of the cathode side plate 31, the intermediate plate 32, and the anode side plate 33 shown in FIG. 1 correlate to the cross section views of the A-A cross section in FIG. 3 to FIG. 5.

The cathode side plate 31 has holes 3140 through 3145 and holes 50 and 51. The intermediate plate 32 has holes 3240 through 3244 and hole 34. The anode side plate 33 has holes 3340 through 3345 and holes 53 and 54.

The hole 3140 provided on the cathode side plate 31 and the hole 3340 provided on the anode side plate 33 are provided at positions and in shapes such that the holes 3140 and 3340 overlap with the hole 40 of the MEA integrated seal unit 20 when they are projected in the lamination direction of the MEA integrated seal unit 20 and the separator 30. The hole 3240 provided on the intermediate plate 32 is similarly provided at a position and in a shape such that a part of the hole 3240 (hereafter noted as “first part 3230”) overlaps the hole 40 of the MEA integrated seal unit 30, the hole 3140 of the cathode side plate 31, and the hole 3340 of the anode side plate 33, when projected in the lamination direction.

In the fuel cell 1, the hole 40 of the MEA integrated seal unit 20, the hole 3140 of the cathode side plate 31, the hole 3240 of the intermediate plate 32, and the hole 3340 of the anode side plate 33 form part of the oxidation gas supply manifold MOp for supplying oxidation gas to the MEA 22 to be used for the electrochemical reaction (see FIG. 1). Note that in FIG. 1, the arrow AOi shows the flow of the oxidation gas supplied to the MEA 22.

The hole 3141 provided on the cathode side plate 31 and the hole 3341 provided on the anode side plate 33 are provided at positions and in shapes such that the holes 3141, 3341 overlap the hole 41 of the MEA integrated seal unit 20 when they are projected in the lamination direction of the MEA integrated seal unit 20 and the separator 30. The hole 3241 provided on the intermediate plate 32 is provided at a position and in a shape such that a part of the hole 3241 (hereafter noted as “first part 3231”) overlaps the hole 41 of the MEA integrated seal unit 20, the hole 3141 of the cathode side plate 31, and the hole 3341 of the anode side plate 33 when projected in the lamination direction.

In the fuel cell 1, the hole 41 of the MEA integrated seal unit 20, the hole 3141 of the cathode side plate 31, the hole 3241 of the intermediate plate 32, and the hole 3341 of the anode side plate 33 form part of the oxidation gas exhaust manifold MOe for exhausting the oxidation gas to outside the fuel cell 1 after being used for the electrochemical reaction (see FIG. 1). Note that in FIG. 1, the arrow AOo shows the flow of the oxidation gas exhausted from the MEA 22.

The hole 3144 provided on the cathode side plate 31, part of the hole 3244 provided on the intermediate plate 32 (hereafter noted as “first part 3234”), and the hole 3344 provided on the anode side plate 33 are provided at positions and in shapes such that they overlap the hole 44 of the MEA integrated seal unit 20 when they are projected in the lamination direction. In the fuel cell 1, these holes form part of the fuel gas supply manifold for supplying fuel gas to the MEA 22 to be used for the electrochemical reaction.

The hole 3143 provided on the cathode side plate 31, part of the hole 3243 provided on the intermediate plate 32 (hereafter noted as “first part 3233”), and the hole 3343 provided on the anode side plate 33 are provided at positions and in shapes such that they overlap the hole 43 of the MEA integrated seal unit 20 when they are projected in the lamination direction. In the fuel cell 1, these holes form part of the fuel gas exhaust manifold for exhausting the fuel gas to outside the fuel cell 1 after it is used for the electrochemical reaction.

The hole 3142 provided at the cathode side plate 31 and the hole 3342 provided at the anode side plate 33 are provided at positions and in shapes such that they overlap the hole 42 of the MEA integrated seal unit 20 when projected in the lamination direction. In the fuel cell 1, these holes form part of the refrigerant supply manifold for supplying refrigerant that flows through the refrigerant flow path within the separator 30.

The hole 3145 provided on the cathode side plate 31 and the hole 3345 provided on the anode side plate 33 are provided at positions and in shapes such that they overlaps the hole 45 of the MEA integrated seal unit 20 when they are projected in the lamination direction. In the fuel cell 1, these holes form part of the refrigerant exhaust manifold for exhausting to outside the fuel cell 1 the refrigerant that has flowed through the refrigerant flow path inside the separator 30.

As shown in the top of FIG. 4, the hole 3240 of the intermediate plate 32 has a part that does not overlap with the hole 3140 of the cathode side plate 31 and the hole 3340 of the anode side plate 33. A portion of the part of the hole 3240 (hereafter noted as “second part 3246”) is provided in a comb tooth shape. Specifically, the second part 3246 of the hole 3240 is divided into a plurality of flow path parts 55 by a plurality of partition parts 322 of the intermediate plate 32. The tip of each flow path part 55 is at a position such that it overlaps the hole 50 of the cathode side plate 31 when it is projected in the lamination direction.

As shown by the arrow AOi at the bottom of FIG. 1, the flow path part 55 of the intermediate plate 32 receives the oxidation gas that flows through the oxidation gas supply manifold MOp (constituted by the hole 40 of the MEA integrated seal unit 20, the hole 3140 of the cathode side plate 31, the hole 3240 of the intermediate plate 32, and the hole 3340 of the anode side plate 33 and the like). Then, that oxidation gas is supplied to the gas flow path unit 26 via the hole 50 of the cathode side plate 31.

As shown at the bottom of FIG. 4, the hole 3241 of the intermediate plate 32 has a part that does not overlap with the hole 3141 of the cathode side plate 31 and the hole 3341 of the anode side plate 33. A portion of the part of the hole 3241 (hereafter noted as “second part 3247”) is provided in comb tooth shape. Specifically, the second part 3247 of the hole 3241 is divided into a plurality of the flow path parts 56 by a plurality of partition parts 323 of the intermediate plate 32. The tip of each flow path part 56 is at a position overlapping the hole 51 of the cathode side plate 31, when it is projected in the lamination direction.

As shown by the arrow AOo at the bottom of FIG. 1, the flow path part 56 of the intermediate plate 32 receives the oxidation gas from the gas flow path unit 26 via the hole 51 of the cathode side plate 31 after it is used for the electrochemical reaction. Then, that oxidation gas is exhausted to the oxidation gas exhaust manifold MOe (constituted by the hole 41 of the MEA integrated seal unit 20, the hole 3141 of the cathode side plate 31, the hole 3241 of the intermediate plate 32, and the hole 3341 of the anode side plate 33 and the like).

As shown in the upper right of FIG. 4, the hole 3244 of the intermediate plate 32 has a part that does not overlap with the hole 3144 of the cathode side plate 31 and the hole 3344 of the anode side plate 33.

The part (hereafter noted as “second part 3248”) is also provided in a comb tooth shape. The second part 3248 of the hole 3244 is divided into a plurality of flow path parts 57 by the plurality of partition parts 326 of the intermediate plate 32. The tip of each flow path part 57 is at a position overlapping the hole 54 of the anode side plate 33 when it is projected in the lamination direction.

The flow path part 57 of the intermediate plate 32 receives the fuel gas that flows through the fuel gas supply manifold (constituted by the hole 44 of the MEA integrated seal unit 20, the hole 3144 of the cathode side plate 31, the hole 3244 of the intermediate plate 32, the hole 3344 of 25 the anode side plate 33 and the like). Then, that fuel gas is supplied to the gas flow path unit 27 via the hole 54 of the anode side plate 33. The fuel gas flows from front side to back side of the paper along the direction perpendicular to the paper surface of FIG. 1 inside the gas flow path unit 27.

As shown at the lower left of FIG. 4, the hole 3243 of the intermediate plate 32 has a part that does not overlap with the hole 3143 of the cathode side plate 31 and the hole 3343 of the anode side plate 33. The part (hereafter noted as “second part 3249”) is provided in a comb tooth shape. Specifically, the second part 3247 of the hole 3243 is divided into a plurality of flow path parts 58 by a plurality of partition parts 327 of the intermediate plate 32. The tip of each flow path part 58 is at a position overlapping the hole 53 of the anode side plate 33 when it is projected in the lamination direction.

The flow path part 58 of the intermediate plate 32 receives the fuel gas from the gas flow path unit 27 via the hole 53 of the anode side plate 33 after it is used for the electrochemical reaction. Then, that fuel gas is exhausted to the fuel gas exhaust manifold (constituted by the hole 43 of the MEA integrated seal unit 20, the hole 3143 of the cathode side plate 31, the hole 3243 of the intermediate plate 32, and the hole 3343 of the anode side plate 33 and the like).

The plurality of holes 34 provided in the intermediate plate 32 are provided at positions and in shapes such that one ends of the plurality of holes 34 overlap the hole 42 of the MEA integrated seal unit 20, the hole 3142 of the cathode side plate 31, and the hole 3342 of the anode side plate 33 when they are projected in the lamination direction (see FIG. 4). The holes 34 provided in the intermediate plate 32 are provided at positions and in shapes such that the other ends of the holes 34 overlap the hole 45 of the MEA integrated seal unit 20, the hole 3145 of the cathode side plate 31, and the hole 3345 of the anode side plate 33 when they are projected in the lamination direction. The hole 34 in the intermediate plate 32 forms the refrigerant flow path 34 in a state sandwiched by the cathode side plate 31 and the anode side plate 33 (see FIG. 1).

The refrigerant flow path 34 of the intermediate plate 32 receives the coolant water that flows through the refrigerant supply manifold (constituted by the hole 42 of the MEA integrated seal unit 20, the hole 3142 of the cathode side plate 31, the hole 3342 of the anode side plate 33 and the like). Then, that coolant water, while flowing inside the refrigerant flow path 34, receives heat from the MEA integrated seal unit 20 via the gas flow path units 26 and 27, and cools the MEA integrated seal unit 20. After that, the coolant water is exhausted to the refrigerant exhaust manifold (constituted by the hole 45 of the MEA integrated seal unit 20, the hole 3145 of the cathode side plate 31, the hole 3345 of the anode side plate 33 and the like).

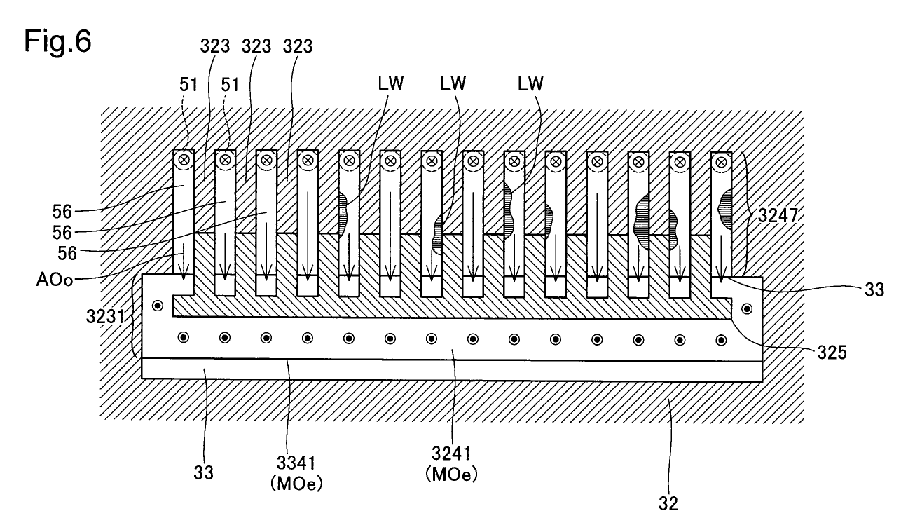

FIG. 6 is an expanded view near the hole 3241 of the intermediate plate 32 shown at the bottom of FIG. 4. In FIG. 6, a part of the anode side plate 33 to be stacked from back side of the paper to the intermediate plate 32 is simultaneously shown. Also, the hole 51 of the cathode side plate 31 to be stacked from front side of the paper to the intermediate plate 32 is shown by the broken line.

In FIG. 6, at the locations where the oxidation gas flows in the direction from front side to back side of the paper are marked with an X on a circle. Then, the locations where the oxidation gas flows from back side to front side of the paper are marked with a dot on a circle.

Of the hole 3241, the second part 3247 that does not overlap with the hole 3341 of the anode side plate 33 is divided into a plurality of flow path parts 56 by a plurality of partition parts 323 of the intermediate plate 32. Then, a shared oscillating portion 325 is provided at the tip of the plurality of the partition parts 323.

The oscillating portion 325 is provided at a position and in a shape such that a part of the oscillating portion 325 overlaps the hole 3341 of the anode side plate 33 (see FIG. 6). Also, the oscillating portion 325 is provided in a thinner state than the partition part 323 and other parts of the intermediate plate 32. Accordingly, even in a state when the intermediate plate 32 is laminated arranged between the anode side plate 33 and the cathode side plate 31, the oscillating portion 325 can be bowed in a direction perpendicular to the paper surface of FIG. 6 when outside pressure is applied. Note that with FIG. 6, of the intermediate plate 32, the parts provided at the same thickness are noted marked by the same hatching.

The oscillating portion 325 can be formed using press processing when forming the intermediate plate 32. It is also possible to form the intermediate plate 32 stacking a plurality of plate members. With this kind of mode, the oscillating portion 325 can be formed by having a lower lamination count of the plate members than the other parts of the intermediate plate 32.

In the fuel cell 1, the oxidation gas that flowed through the gas flow path unit 26 flows into the flow path part 56 of the intermediate plate 32 (see the arrow AOo at the lower left part of FIG. 1) through the hole 51 of the cathode side plate 31 (shown by broken lines in FIG. 6) in the direction to the back side of the paper. Then, that oxidation gas goes through the flow path part 56 toward the oxidation gas exhaust manifold MOe including the hole 3241 of the intermediate plate 32 and the hole 3341 of the anode side plate 33. Inside the oxidation gas exhaust manifold MOe, the oxidation gas flows from back side to front side of the paper of FIG. 6.

In FIG. 6, only one intermediate plate 32 and one anode side plate 33 of the separator 30 are shown. However, in the fuel cell 1, a large number of separators 30 and MEA integrated seal units 20 are laminated (see FIG. 1). Therefore, inside the oxidation gas exhaust manifold MOe, the oxidation gas coming from further upstream (further backward from the paper surface of FIG. 6) contacts the oscillating portion 325. As a result, the oscillating portion 325 is shaken by the flow of the oxidation gas.

In the fuel cell 1, the oxidation gas that flows through the gas flow path unit 26 contains moisture. Part of the moisture is water generated by the electrochemical reaction at the MEA 22. There are also cases when the oxidation gas supplied to the oxidation gas supply manifold MOp is humidified in advance. The moisture contained in the oxidation gas is liquefied inside the gas flow path unit 26. This kind of liquefied water is indicated as LW in FIG. 6.

With this embodiment, the water liquefied inside the gas flow path unit 26 is moved by the oscillation of the oscillating portion 325, and is exhausted to the oxidation gas exhaust manifold MOe from the flow path part 56. Also, the water adhered to the oscillating portion 325 is separated from the oscillating portion 325 by the oscillation of the oscillating portion 325, and is blown downstream inside the oxidation gas exhaust manifold MOe. At that time, part of the water which exists inside the gas flow path unit 26 and is connected to the water adhered to the oscillating portion 325 is simultaneously pulled from inside the gas flow path unit 26 and blown downstream inside the oxidation gas exhaust manifold MOe.

Accordingly, with this embodiment, compared to an embodiment which does not have the oscillating portion 325, it is difficult for the flow path part 56 to become clogged by liquefied water. Specifically, the possibility of the oxidation gas flow being blocked is low. Thus, with this embodiment, compared to an embodiment that does not have the oscillating portion 325, the possibility of electrical generation at the fuel cell 1 being inhibited is low.

Also, with this embodiment, a shared oscillating portion 325 is provided at the tips of the plurality of partition parts 323. Accordingly, even when the flow of the gas at part of the oxidation gas exhaust manifold MOe is fast, and the flow of gas at the other parts is slow, it is possible to have a small variation of oscillation volume of the oscillating portion 325 that contacts each flow path part 56. Consequently, it is possible to have the exhaust efficiency of the liquid water at the plurality of flow path parts 56 be about the same level.

Similarly, the oscillating portion 324 (see the top of FIG. 4) is provided at the tips of a plurality of partition parts 322 which divide the second part 3246 of the hole 3240 into the plurality of flow path parts 55. The oscillating portion 324 is also oscillated by the oxidation gas that flows from back side to front side of the paper of FIG. 4. As a result, even when the moisture is liquefied inside the flow path part 55, that water is exhausted to the outside of the flow path part 55 efficiently by the oscillation of the oscillating portion 324. Accordingly, the flow path part 55 does not clog easily, and the possibility of the oxidation gas flow being blocked is low. Thus, with this embodiment, compared to an embodiment that does not have the oscillating portion 324, the possibility of electrical generation at the fuel cell 1 being inhibited is low.

Also, because a shared oscillating portion 324 is provided at the tips of the plurality of partition parts 322, it is possible to have the exhaust efficiency of the liquid water at the plurality of flow path parts 56 be about the same level.

### B. Second Embodiment

In the fuel cell of the second embodiment, the oscillating portions 324 and 325 (see FIG. 4) respectively have holes 324h and 325h. The other points of the fuel cell of the second embodiment are the same as the fuel cell 1 of the first embodiment.

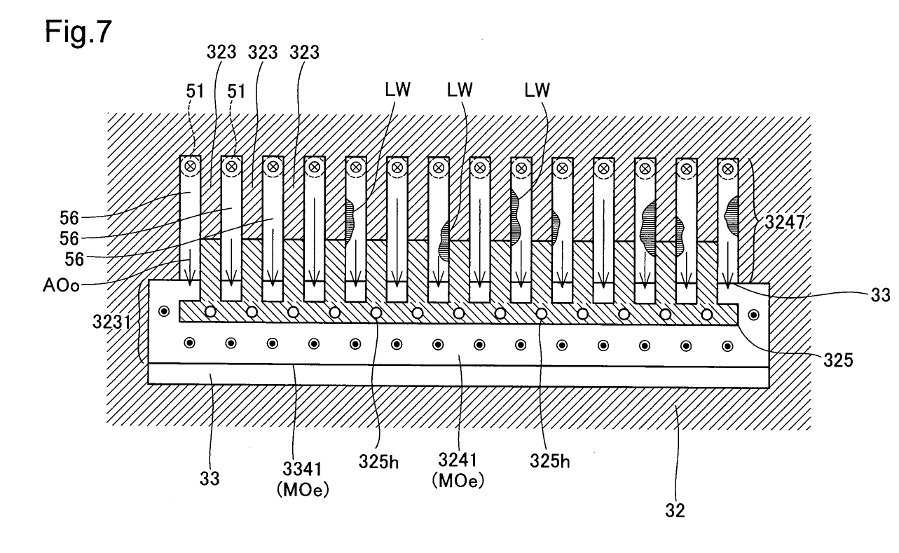

FIG. 7 is an expanded view near the hole 3241 of the intermediate plate 32 of the second embodiment. With the second embodiment, the oscillating portion 325 provided at the tips of the plurality of partition parts 323 has a plurality of holes 325h. The number and surface area of the holes 325h that the oscillating portion 325 has are the same within one separator. Also, the surface area of each hole 325h is smaller the more that the separator 30 is positioned upstream of the flow of the oxidation gas at the oxidation gas exhaust manifold MOe, and is larger the more that the separator 30 is positioned downstream. As a result, the surface area of the oscillating portion 325, when it projects in the lamination direction of the MEA integrated seal units 20 and the separators 30, is larger the more the separator 30 is upstream, and smaller the more the separator 30 is downstream.

Inside the oxidation gas exhaust manifold MOe, the further downstream, the oxidation gas flows in from the more separators 30. Accordingly, the flow volume of oxidation gas per unit of time becomes greater the further downstream inside the oxidation gas exhaust manifold MOe.

By using the second embodiment, on the intermediate plate 32 of the upstream separator 30, it is possible to shake the oscillating portion 325 at about the same level as the intermediate plate 32 of the downstream separator 30 by the flow volume of gas that is less than that downstream. Specifically, by setting the size of the hole 325h of each separator 30 to a suitable value, it is possible to make the size of the oscillation of the oscillating portion 325 of each separator 30 about equal. As a result, it is possible to prevent clogging of the oxidation gas exhaust path for each separator 30 at about the same level.

In the second embodiment, the oscillating portion 324 provided at the tips of the plurality of partition parts 322 have a plurality of holes 324h the same as for the oscillating portion 325. The number and surface area of the holes 324h that the oscillating portion 324 has are the same inside each separator. Also, the surface area of each hole 324h is larger the more the intermediate plate 32 of the separator 30 is positioned upstream of the flow of the oxidation gas at the oxidation gas supply manifold MOp, and is smaller the more that the intermediate plate 32 of the separator 30 is positioned downstream. As a result, the surface area of the oscillating portion 325, when projected in the lamination direction of the MEA integrated seal units 20 and the separators 30, is smaller the more that the separator 30 is upstream, and is larger the more that the separator 30 is downstream.

Inside the oxidation gas supply manifold MOp, oxidation gas is supplied to each separator 30 in contact with the oxidation gas supply manifold MOp. Accordingly, inside the oxidation gas supply manifold MOp, the oxidation gas flows at a smaller volume the further downstream it is. Specifically, the flow volume of oxidation gas per unit of time is smaller the further downstream it is inside the oxidation gas supply manifold MOp.

By using the second embodiment, on the intermediate plate 32 of the downstream separator 30, it is possible to shake the oscillating portion 324 at about the same level as the intermediate plate 32 of the upstream separator 30 using a smaller gas flow volume than upstream. Specifically, by setting the size of the holes 324h of each separator 30 to a suitable value, it is possible to make the size of the oscillation of the oscillating portion 324 of each separator 30 almost equal. As a result, it is possible to prevent clogging of the oxidation gas supply paths for each separator 30 at about the same level.

### C. Third Embodiment

With the fuel cell of the third embodiment, the oscillating portions 324a and 325a are provided individually for a plurality of partition parts 322 and 323 of the intermediate plate 32. The other points of the fuel cell of the third embodiment are the same as for the fuel cell 1 of the first embodiment.

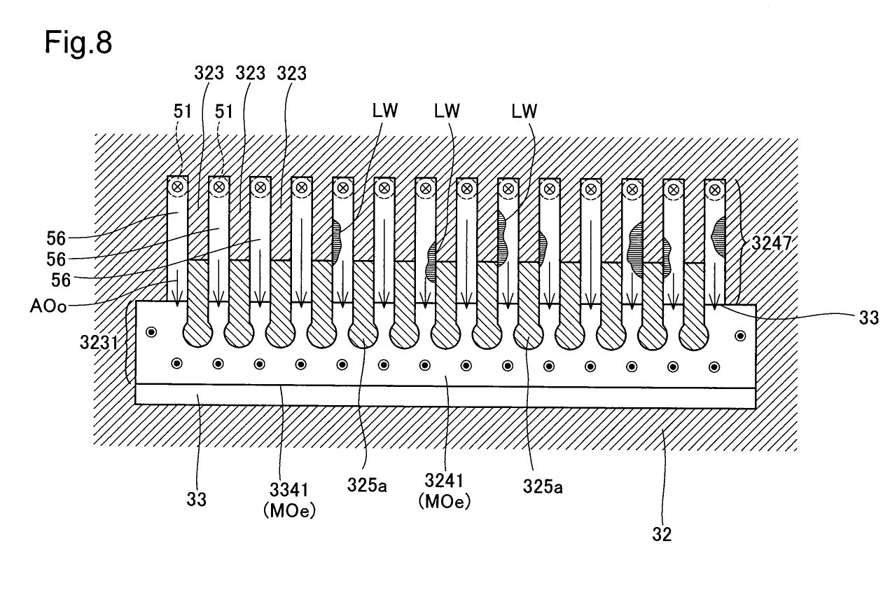

FIG. 8 is an expanded view near the hole 3241 of the intermediate plate 32 for the third embodiment. With the third embodiment, an independent oscillating portion 325a is provided at the tip of each partition part 323. The surface area of each oscillating portion 325a, when projecting in the lamination direction of the MEA integrated seal units 20 and the separators 30, is the same within each separator. Also, the surface area of the oscillating portion 325 is larger the more the separator 30 is upstream, and is smaller the more the separator 30 is downstream.

Also in the third embodiment, with the upstream separator 30, it is possible to shake the oscillating portion 325 at about the same level as the downstream separator 30 with a smaller gas flow volume than downstream. Accordingly, by setting the size of the oscillating portion 325 for each separator 30 to a suitable value, it is possible to make the size of the oscillation of the oscillating portion 325 of each separator 30 almost equal. As a result, it is possible to prevent clogging of the oxidation gas exhaust path in each separator 30 at about the same level.

In the third embodiment, the oscillating portions 324 provided at the tips of the plurality of partition parts 322 also are provided like the oscillating portions 325 individually on each of the partition parts 322. The surface area of each oscillating portion 325, when projecting in the lamination direction of the MEA integrated seal units 20 and the separators 30, is the same inside each separator. Also, the surface area of the oscillating portion 325 is smaller the more the separator 30 is upstream and is larger the more the separator 30 is downstream.

Also in the third embodiment, by setting the size of the oscillating portion 324 for each separator 30 to a suitable value, it is possible to make the size of the oscillation of the oscillating portion 324 of each separator 30 almost equal. As a result, it is possible to prevent clogging of the oxidation gas supply path at each separator 30 at about the same level.

Also with the third embodiment, each oscillating portion is provided independently. Because of that, when the flow of gas is strong in part of the inside of the oxidation gas supply manifold MOp or the oxidation gas exhaust manifold MOe, the oscillating portion positioned at or near that part oscillates strongly. As a result, that oscillation energy is used effectively, and it is possible to efficiently exhaust the water of the flow path adjacent to the partition part connected to that oscillating portion. Specifically, with a mode which has a shared oscillating portion like that of the first and second embodiments, when using oscillation from the part of the oscillating portion at the position at which the gas flow is strong to another part, part of the energy is lost due to attenuation. However, with the third embodiment, there is little of that kind of loss, so it is possible to efficiently exhaust water from the flow path part.

### D. Fourth Embodiment

The fuel cell of the fourth embodiment has an auxiliary oscillating portion 328 at the anode side plate 33 constituting the inner wall of the flow path part 55. Also, the fuel cell of the fourth embodiment has an auxiliary oscillating portion 329 at the anode side plate 33 constituting the inner wall of the flow path 56. Furthermore, the fuel cell of the fourth embodiment has a constitution for the partition parts 322b and 323b as well as oscillating portions 324b and 325b that differ from that of the fuel cell 1 of the first embodiment. The other points of the fuel cell of the fourth embodiment are the same as those of the fuel cell 1 of the first embodiment.

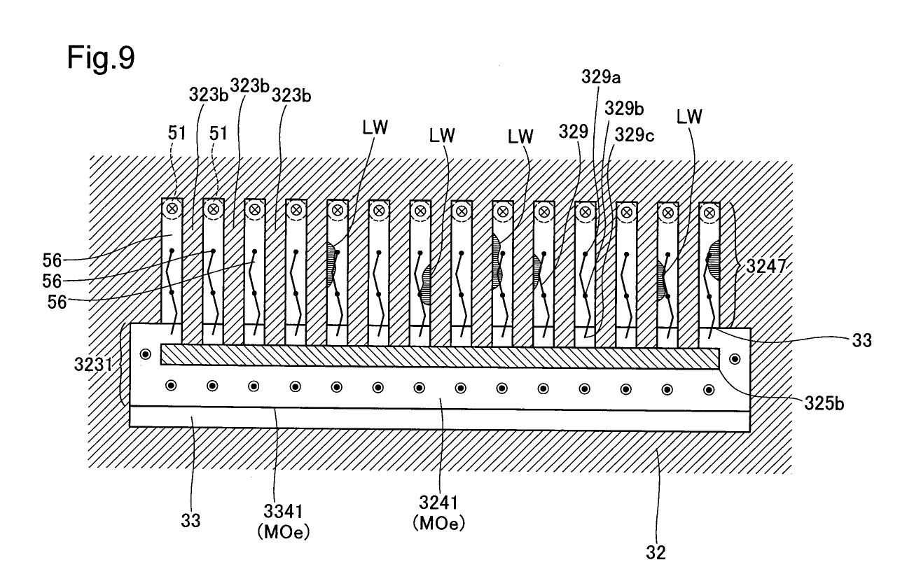

FIG. 9 is an expanded view near the hole 3241 of the intermediate plate 32 for the fourth embodiment. With the fourth embodiment, the tip of each partition part 323b reaches to the position overlapping the hole 3341 of the anode side plate 33. Also, an oscillating portion 325b is provided at the tips of the plurality of those partition parts 323b. Specifically, the oscillating portion 325b that is provided in a thinner state than each partition part 323b is overall provided at a position overlapping the hole 3341 of the anode side plate 33. The partition part 322b and the oscillating portion 324b are provided in the same manner.

The auxiliary oscillating portion 329 is provided at the anode side plate 33 constituting the inner wall of the flow path part 56. The auxiliary oscillating portion 329 is constituted by a wire shaped member having a specific elasticity. The auxiliary oscillating portion 329 has a shape that is bent at two points. The direction of the bend at those two points is the direction such that each side sandwiching the curve points is contained inside the same plane.

The auxiliary oscillating portion 329 is fixed to the anode side plate 33 constituting the inner wall of the flow path part 56 at the one end 329a and the one point 329b between the two curve points. By the elastic deformation, the other parts can move in relation to the anode side plate 33. The other end 329c of the auxiliary oscillating portion 329 reaches the position overlapping the hole 341 of the anode side plate 33.

The auxiliary oscillating portion 329 is constituted so as to have elasticity of a level that oscillates by the flow of the oxidation gas that flows in the flow path part 56. As a result, the liquid water inside the flow path part 56 is exhausted to the oxidation gas exhaust manifold MOe efficiently by not only the oscillation of the oscillating portion 325 but also by the oscillation of the auxiliary oscillating portion 329.

The fuel cell of the fourth embodiment has an auxiliary oscillating portion 328 which has the same constitution as that of the auxiliary oscillating portion 329 also provided at the anode side plate 33 constituting the inner wall of the flow path part 55. As a result, the liquid water inside the flow path part 55 is exhausted to outside the flow path part 55 efficiently not only by the oscillation of the oscillating portion 324 but also by the oscillation of the auxiliary oscillating portion 328.

### E. Fifth Embodiment

With the fuel cell of the fifth embodiment, the oscillating portion is not provided at the tips of the plurality of partition parts 323c of the intermediate plate 32. Also, the partition part 323c is provided at the same thickness up to the tip. The other points of the fuel cell of the fifth embodiment are the same as those of the fuel cell 1 of the first embodiment.

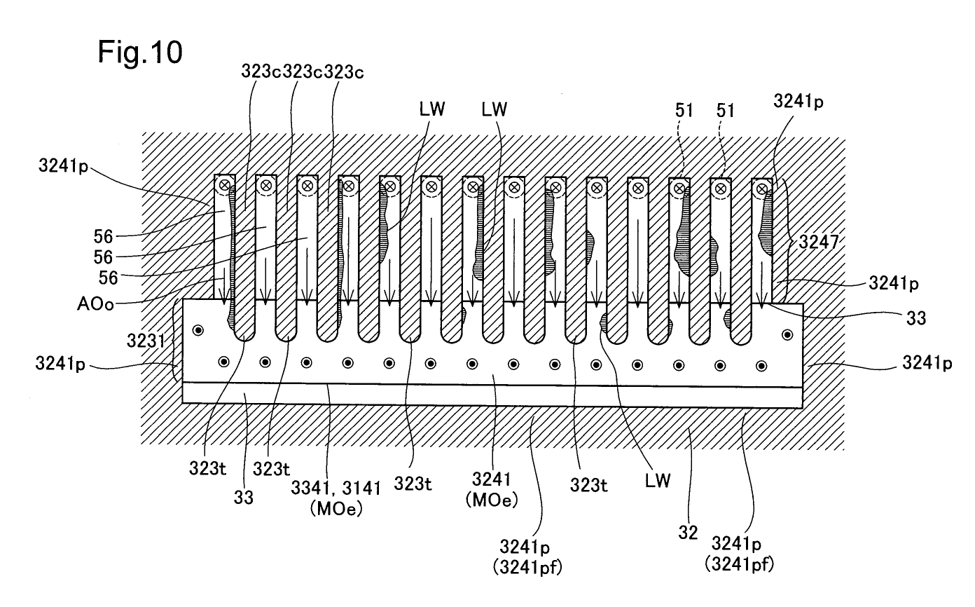

FIG. 10 is an expanded view near the hole 3241 of the intermediate plate 32 for the fifth embodiment. The same as with the intermediate plate 32 of the first embodiment, the hole 3241 of the intermediate plate 32 of the fifth embodiment has a first part 3231 and a second part 3247. The first part 3231 overlaps the hole 3141 of the cathode side plate 31 (in FIG. 10, it exists in the area overlapping the hole 3341). The second part 3247 does not overlap the hole 3141 of the cathode side plate 31, and does partly overlap the hole 51 of the cathode side plate 31.

Each partition part 323cis constituted to have a length such that the tip part 323t of partition part 323c is positioned inside the oxidation gas exhaust manifold MOe, when the cathode side plate 31, the intermediate plate 32, and the anode side plate 33 are stacked. The oxidation gas exhaust manifold MOe is constituted by the hole 3141 of the cathode side plate 31, the first part 3231 of the hole 3241 of the intermediate plate 32, and the hole 3341 of the anode side plate 33 (see FIG. 1 and FIG. 10). Specifically, each partition part 323c is constituted so that its tip part 323t is positioned overlapping the holes 3141 and 3341.

Also, the partition part 323c is provided at the same thickness as the other part 3241p that constitutes the outer periphery of the hole 3241 of the intermediate plate 32 up to the tip part 323t.

With the fifth embodiment, the water that is liquefied inside the gas flow path unit 26 (see FIG. 1) adheres to the partition part 323c inside the hole 3241 of the intermediate plate 32. Also, that water is conveyed on the partition part 323c and moves up to the tip part 323t inside the oxidation gas exhaust manifold MOe. Note that in many cases, the water inside the gas flow path unit 26 (see FIG. 1) is connected to the water adhered to the partition part 323c inside the hole 3241.

The water adhered to the tip part 323t of the partition part 323c is separated from the tip part 323t by the flow of oxidation gas inside the oxidation gas exhaust manifold MOe, and is blown downstream inside the oxidation gas exhaust manifold MOe. At that time, part of the water which existed inside the gas flow path unit 26 and was linked to the water adhered to the tip part 323t is simultaneously pulled from inside the gas flow path unit 26 and blown downstream inside the oxidation gas exhaust manifold MOe.

With the fifth embodiment, compared to an embodiment that does not have the partition part 323c and a embodiment in which the tip part 323t of the partition part 323c is not inside the oxidation gas exhaust manifold MOe, the flow path part 56 does not clog easily due to liquefied water. Specifically, the possibility of the flow of the oxidation gas being blocked is low. Thus, with this embodiment, compared to the embodiment that does not have the partition part 323c and the embodiment in which the tip part 323t of the partition part 323c is not inside the oxidation gas exhaust manifold MOe, the possibility of electrical generation with the fuel cell 1 being inhibited is low.

Also, with the fifth embodiment, the partition part 323c is not constituted so as to divide the first part 3231 that constitutes the oxidation gas exhaust manifold MOe. To say this another way, the tip of the partition part 323c does not reach the part 3241pf that constitutes the outer peripheral part that faces the hole 3241 of the intermediate plate 32. Accordingly, compared to an embodiment in which the tip of the partition part reaches the other parts that constitute the outer periphery of the oxidation gas exhaust manifold, the surface area projecting in the flow path direction is small with the constitution in which the oxidation gas flow is blocked within the oxidation gas exhaust manifold. Thus, it is possible to lower the pressure loss within the oxidation gas exhaust manifold.

### F. Variation Examples

This invention is not limited to the embodiments noted above, and it is possible to implement this in various modes in a range that does not stray from the key points, with the following kinds of variations being possible, for example.

### F1. Variation Example 1

With the aforementioned first to fourth embodiments, the oscillating portions 325, 324 and the like are provided in a thinner state compared to the partition parts 323 and 322, and other parts of the intermediate plate 32. However, the oscillating portion can also be provided at the same thickness as the partition parts 323 and 322 and the other parts of the intermediate plate 32. It is also possible to provide the part that overlaps with the hole 3341 of the anode side plate 33 and the hole 3141 of the cathode side plate 31 to be thicker than the partition parts. Furthermore, the oscillating portion can also have parts with mutually different thicknesses. However, at least at part, it is preferable to have a rigidity and shape of a level which enables the elastic deformation by the flow of the reaction gas during operation of the fuel cell.

### F2. Variation Example 2

With the aforementioned first to fourth embodiments, the oscillating portions 324 and 325 are supported or connected to the tips of the partition parts 322 and 323. However, the oscillating portions 324 and 325 can also be connected to the intermediate plate via the wire shaped auxiliary oscillating portions 328 and 329 having a specified elasticity.

Also, with the aforementioned first to fourth embodiments, the oscillating portions 324 and 325 have a plate shape. However, the oscillating portions 324 and 325 can also have a three dimensional shape.

### F3. Variation Example 3

With the aforementioned fourth embodiment, the wire shaped auxiliary oscillating portions 328 and 329 are equipped together with plate shaped oscillating portions 324 and 325 with the separator 30. However, the separator 30 can also be an aspect that is not equipped with an oscillating portion in a plate shape, and that is equipped only with a wire shaped auxiliary oscillating portion. Specifically, the name auxiliary oscillating portion is used for convenience with the fourth embodiment, but this does not mean it is always used together with other oscillating portions.

### F4. Variation Example 4

With the aforementioned embodiments, the fuel cell 1 has gas flow path units 26 and 27 constituted using porous body metal. However, other aspect is also possible for which the fuel cell 1 does not have the gas flow path unit 26 or 27. For example, it is possible to use an embodiment in which the fuel cell has a serpentine flow path on the separator, and the MEA is directly stacked on the separator.

### F5. Variation Example 5

In the aforementioned embodiments, as examples, the present invention is applied to the oxidation gas flow path. However, the present invention is not limited to the oxidation flow path, and it is also possible to apply this to the fuel gas flow path. In the fuel cell system, the fuel gas is sometimes humidified in advance before the fuel gas is supplied to the MEA. Accordingly, by applying the present invention to the fuel gas flow path, it is possible to reduce the possibility of the fuel gas flow path becoming clogged by the liquefied water added to the fuel gas.

### F6. Variation Example 6

With the aforementioned fourth embodiment, the auxiliary oscillating portion 329 is provided on the anode side plate 33 constituting the inner wall of the flow path part 56. However, the auxiliary oscillating portion or the oscillating portion provided so as to be oscillated by the flow of gas can also be provided on the cathode side plate that constitutes the inner wall of the flow path part. Specifically, the auxiliary oscillating portion or the oscillating portion can be provided in the inner wall part of the flow path part. Also, the auxiliary oscillating portion or the oscillating portion can be provided on a part that does not constituted the inner wall part of the flow path part of the partition part, such as the tip of the partition part or the like.

### F7. Variation Example 7

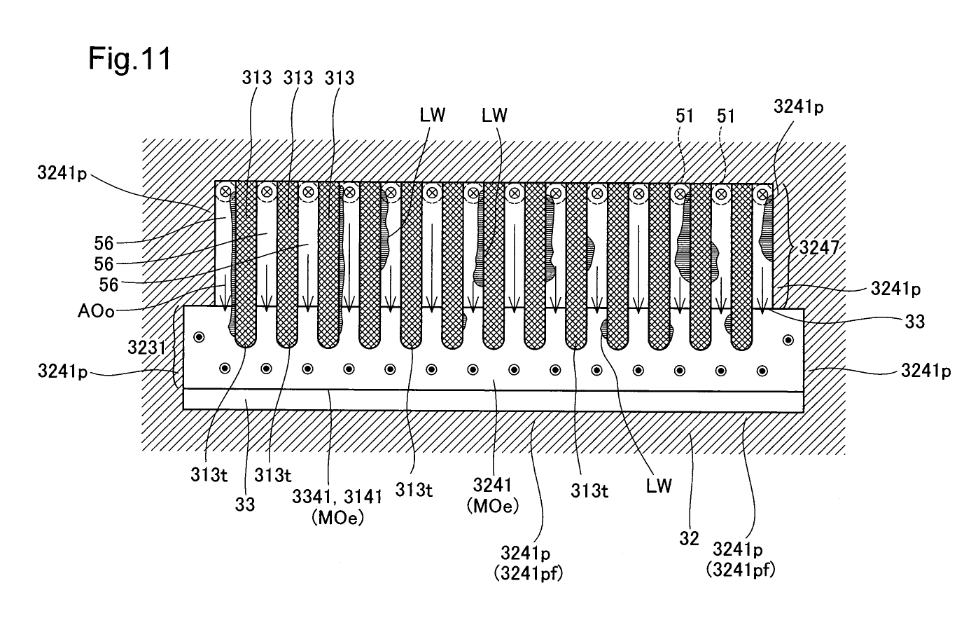

FIG. 11 is an expanded view near the hole 3241 of the intermediate plate 32 with the variation example 7. With each of the aforementioned embodiments, the partition parts 323, 323b, and 323c are provided on the intermediate plate 32 (see FIG. 6 to FIG. 10). However, the partition part can also be provided on the cathode side plate 31 or the anode side plate 33. Except for the partition part, the constitution of the variation example 7 is the same as that of embodiment 5.

In FIG. 11, the partition part 313 is provided on the cathode side plate 31. On the cathode side plate 31, the partition part 313 projects toward the intermediate plate 32 and the anode side plate 33 stacked on the cathode side plate 31. As a result, in a state stacking the cathode side plate 31, the intermediate plate 32, and the anode side plate 33, the partition part 313 respectively divides the second parts 3247 of the hole 3241 of the intermediate plate 32 into a plurality of flow path parts 56 through which the oxidation gas flows. Note that with variation example 7, of the cathode side plate 31 constitution, the part included in the cross section of FIG. 11 is only the partition part 313 shown by cross hatching.

With variation example 7 as well, water liquefied inside the gas flow path unit 26 (see FIG. 1) adheres to the partition part 313 inside the hole 3241 of the intermediate plate 32. Also, that water is conveyed on the partition part 313 and moves to the tip part 313t of the partition part 313 inside the oxidation gas exhaust manifold MOe. After that, that water is separated from the tip part 313t by the flow of oxidation gas inside the oxidation gas exhaust manifold MOe, and is blown downstream inside the oxidation gas exhaust manifold MOe. At that time, part of the water that exists inside the flow path part 26 and is linked to the water adhered to the tip part 313t is also simultaneously pulled from inside the gas flow path unit 26 and blown downstream inside the oxidation gas exhaust manifold MOe.

Accordingly, with variation example 7 as well, the same as with the fifth embodiment, the flow path part 56 is not easily clogged by liquefied water. Specifically, the possibility of the flow of the oxidation gas being blocked is low. As a result, the possibility of electrical generation at the fuel cell 1 being inhibited is low.

Also, with variation example 7, the tip of the partition part 313 does not reach the facing part constituting the outer periphery part of the hole 3141 of the cathode side plate 31, or the facing part 3241pf constituting the outer periphery part the hole 3241 of the intermediate plate 32. Accordingly, the surface area of the constitution, when projected in the flow path direction, blocking the flow of the oxidation gas inside the oxidation gas exhaust manifold is small. Thus, it is possible to reduce the pressure loss inside the oxidation gas exhaust manifold.

### F8. Variation Example 8

With the aforementioned fifth embodiment, the partition part 323c is provided at the same thickness up to the tip part 323t, as the other part 3241p constituting the outer periphery of the hole 3241 of the intermediate plate 32. However, an aspect is also possible in which at least part of the partition part that divides the second part 3231 of the hole 3241 of the intermediate plate is provided in a thinner state than the other part 3241p that constitutes the outer periphery of the hole 3241.

In this aspect, the part between the partition part and the first plate 31 constitutes a flow path of which the thickness is thinner than that of the other part of the second part 3247 of the hole 3241. Of the second part 3247 of the hole 3241, the part that constitutes the flow path that is thicker than the part between the partition part and the first plate 31 is the flow path part divided by the partition part.

Specifically, the partition part may divide the plurality of flow path parts independently. The second part may be divided into a plurality of flow path parts in such a manner that at least part of the plurality of flow path parts may communicate with each other. The separator may have the plurality of flow path parts independent from each other, or the plurality of flow path parts of which at least part communicate with each other.

The invention of this application is described in detail while referring to preferred representative embodiments. However, the invention of this application is not limited to the embodiments and constitutions described above. Also, the invention of this application includes various variations and equivalent constitutions. Furthermore, the various elements of the disclosed invention are disclosed using various combinations and constitutions, but these are representative examples, and there can be more of or less of each element. It is also possible to use just one element. Those variation are also included in the scope of the invention of this application.

1. A fuel cell separator, comprising:
a first plate having a first hole through which reaction gas flows; and
a second plate that is to be stacked with the first plate, the second plate having a second hole through which the reaction gas flows, the second hole being in fluid communication with the first hole, wherein
the second hole has: a first part that overlaps with the first hole; and a second part that does not overlap with the first hole,
the second plate has a partition part that divides the second part into a plurality of flow path parts through which the reaction gas flows respectively, and
the separator further comprises an oscillating portion that is connected to the partition part or other inner wall that constitutes the flow path part, the oscillating portion being arranged at a position in which at least part of the oscillating portion overlaps with the first hole of the first plate, and being configured to be shaken by the reaction gas that flows inside the first hole during operation of the fuel cell.

2. A fuel cell separator in accordance with claim 1, wherein
the oscillating portion is connected to the partition part or other inner wall part that constitutes the flow path part at the second part side from among the first part side and the second part side of the second hole, and is not connected to a part that constitutes the first or second plate at the first part side.

3. A fuel cell separator in accordance with claim 1, wherein
the second plate has a plurality of partition parts, and
the plurality of partition parts are connected to one oscillating portion.

4. A fuel cell separator in accordance with claim 1, wherein
the second plate has a plurality of partition parts, and
the plurality of partition parts are connected to respectively different oscillating portions.

5. A fuel cell separator, comprising:
a first plate having a first and second holes through which reaction gas flows; and
a second plate that is to be stacked with the first plate, the second plate having a third hole through which the reaction gas flows, wherein
the third hole has: a first part that overlaps with the first hole; and a second part that does not overlap with the first hole but partly overlaps with the second hole,
at least one of the first plate and the second plate has a partition part which divides, in a state that the first plate and the second plate being stacked, at least part of the second part into a plurality of flow path parts through which the reaction gas flows respectively, and
a tip of the partition part is positioned overlapping with the first hole.

6. A fuel cell, comprising:
a plurality of separators; and
a membrane electrode assembly arranged between the plurality of separators, wherein
each of the plurality of separators comprises:
a first plate having a first hole through which reaction gas flows; and
a second plate that is to be stacked with the first plate, the second plate having a second hole through which the reaction gas flows, the second hole being in fluid communication with the first hole, wherein
the second hole has: a first part that overlaps with the first hole; and a second part that does not overlap with the first hole,
the second plate has a partition part that divides the second part into a plurality of flow path parts through which the reaction gas flows respectively, and
the separator further comprises an oscillating portion that is connected to the partition part or other inner wall that constitutes the flow path part, the oscillating portion being arranged at a position in which at least part of the oscillating portion overlaps with the first hole of the first plate, and being configured to be shaken by the reaction gas that flows inside the first hole during operation of the fuel cell.

7. A fuel cell in accordance with claim 6, wherein
the plurality of separators are stacked so that at least part of the first holes mutually overlap,
during operation of the fuel cell, the reaction gas exhausted from the membrane electrode assembly via the second holes of the separators flows in a specified direction along the stacking direction in the first holes of the plurality of stacked separators, and
a first separator from among the plurality of separators comprises the oscillating portion of which surface area is smaller, when projected in the stacking direction, than that of a second separator from among the plurality of separators, which is positioned upstream of the first separator in the direction of the flow of the reaction gas.

8. A fuel cell in accordance with claim 6, wherein
the plurality of separators are stacked so that at least part of the first holes mutually overlap,
during operation of the fuel cell, the reaction gas supplied to the membrane electrode assembly via the second holes of the separators flows in a specified direction along the stacking direction in the first holes of the plurality of stacked separators, and
a first separator from among the plurality of separators comprises the oscillating portion of which surface area is larger, when projected in the stacking direction, than that of a second separator from among the plurality of separators, which is positioned at upstream of the first separator in the direction of the flow of the reaction gas.

9. A fuel cell, comprising:
a plurality of separators; and
a membrane electrode assembly arranged between the plurality of separators, wherein
each of the plurality of separators comprises:
a first plate having a first and second holes through which reaction gas flows; and
a second plate that is to be stacked with the first plate, the second plate having a third hole through which the reaction gas flows, wherein
the third hole has: a first part that overlaps with the first hole; and
a second part that does not overlap with the first hole but partly overlaps with the second hole,
at least one of the first plate and the second plate has a partition part which divides, in a state that the first plate and the second plate being stacked, at least part of the second part into a plurality of flow path parts through which the reaction gas flows respectively, and
a tip of the partition part is positioned overlapping with the first hole.
